(19) United States
(12) Patent Application Publication
(10) Pub. No.: US 2026/0338496 A1
(43) Pub. Date: Oct. 29, 2026

(54) HEAT AND HUMIDITY EXCHANGERS COMPRISING ENCLOSED MEMBRANE STRUCTURES, AND THE MANUFACTURE THEREOF

(71) Applicant: CORE ENERGY RECOVERY SOLUTIONS INC., Vancouver (CA)

(72) Inventors: Juan Pablo Loustaunau Lopez, Burnaby (CA); Jonathan Mong Ling Lo, Vancouver (CA); Ryan Nicholas Huizing, Vancouver (CA)

(21) Appl. No.: 19/431,170

(22) Filed: Dec. 23, 2025

Related U.S. Application Data
(60) Provisional application No. 63/738,650, filed on Dec. 24, 2024.

(51) Int. Cl. F28D 21/00; B23P 15/26

(52) U.S. Cl. CPC F28D 21/0015; B23P 15/26

(57) ABSTRACT

Methods for forming an enclosed membrane structure for a heat and humidity exchanger and the resulting structures are provided. The structure is formed from a sheet of water vapor permeable membrane by joining its edges to create a seam. To reduce stress concentration and subsequent failure, the seam can incorporate non-linear geometry. An adhesive strip having non-linear edges, such as wavy or scalloped edges, may be applied to the membrane edges to form the seam, or the seam may be a welded seam including at least one weld line having a non-linear path. The welded seam may be formed by welding the membrane edges directly to each other or to a backing strip.

### FIELD

The present invention relates to heat and humidity exchangers comprising enclosed membrane structures, such as membrane sleeves, and methods for the manufacture thereof. In particular, the present invention relates to joining or bonding membrane-to-membrane in the formation of enclosed membrane structures, and the use of such enclosed membrane structures in heat and humidity exchanger cores.

### BACKGROUND

Air-to-air membrane-based heat and humidity exchangers (also sometimes referred to as humidifiers) have been developed for a variety of applications, including building ventilation (HVAC), medical and respiratory applications, gas drying, and humidifying fuel cell reactants supplied to fuel cells for electrical power generation.

Planar plate-type heat and humidity exchangers generally use flat sheets of water vapor permeable membranes supported between separators. The membrane sheets are typically stacked, sealed and configured with alternating gas distribution layers separated by membrane sheets to accommodate intake and exhaust streams flowing in either cross-flow or counter-flow configurations between alternate membrane sheets, so that heat and humidity are transferred between the streams via the membrane.

FIG. 1 illustrates, in a partial cut-away view, an example of a planar plate-type heat and humidity exchanger core 100 made from stacked planar sheets of water vapor permeable membrane 110 with rigid corrugated separators 120 inserted between the membrane sheets. The separators support the membrane and maintain proper sheet spacing, as well as defining channels 130 for wet and dry streams flowing on opposite faces of each membrane sheet, in a cross-flow arrangement, as indicated by broad arrows 140 and 150 respectively. The membrane material is typically thin, flexible and not self-supporting. The separators 120 support the membrane, and reduce or prevent deflection of the membrane into channels 130. The stack is typically encased within a rigid frame or housing 160 to form the “core” of a heat and humidity exchanger. In some heat and humidity exchangers, plastic or metal flow field elements are used instead of corrugated separators, on one or both sides of the membrane sheets, to provide support for the membrane, maintain spacing and provide flow channels for the streams on one or both faces of the membrane sheets. In some heat and humidity exchangers, spacers (such as rods or strips of material) are used instead of corrugated separators on one or both faces of the membrane sheets, to provide support for the membrane, maintain spacing and provide flow channels for the streams on one or both faces of the membrane sheets.

Examples of heat and humidity exchangers comprising stacked sheets of membrane interleaved with corrugated separators are described, for example, in US Patent Application Publication No. US2011/0192579. Examples of heat and humidity exchangers with flow field elements inserted between sheets of membrane are described, for example, in U.S. Pat. Nos. 7,331,376 and 8,235,093.

In some heat and humidity exchangers, the membrane is pleated and flow field elements are disposed within the folds of the pleated membrane to direct the flow of fluid streams across opposing surfaces of the membrane. For example, FIG. 2 illustrates a pleated membrane cartridge 200 comprising a pleated membrane 210 that has flow field elements 220a and 220b disposed in folds 220 of pleated membrane 210, in an alternating arrangement. For illustration purposes, a first flow field element 220a has been pulled out of a pleat on one side of cartridge 200, and a second flow field element 220b has been pulled out of a pleat on the other side of cartridge 200. In this example the two exposed flow field elements are substantially the same, with the respective fluid stream being directed in a U-shaped flow path by the flow field element within each fold.

In some heat and humidity exchangers, flow field features or spacers are formed directly on one or both surfaces of the membrane sheets. In some heat and humidity exchangers, the membrane sheets are bonded to other components of the humidifier, for example, using an adhesive or sealant, or by welding. For example, in some heat and humidity exchangers a separator or flow field element is attached to one or both surfaces of membrane using an adhesive or sealant, or by welding.

Examples of heat and humidity exchangers comprising stacked panels with spacers in between adjacent panels, where the panels are made up of membrane sheets bonded to both faces of a separator, are described in U.S. Pat. No. 10,845,068. Examples of fuel cell humidifiers comprising stacked unit cells, where the unit cells are made up of membrane sheets bonded to both faces of a separator, are described in US Patent Application Publication No. US2024/0021847.

In some heat and humidity exchangers it is desirable to be able to bond a water vapor permeable membrane to itself. For example, Published PCT Application No. WO/2022/096287 describes an exchanger, for transferring water vapor between two gases, that can be part of an air-conditioning system or a fuel cell humidifier. The flat membrane exchanger comprises a stack of membrane pockets disposed in a housing, each membrane pocket having two membranes that are selectively permeable to water vapor, and that are welded gas tight at their edges.

The preferred method(s) of attachment of a membrane to another component of a heat and humidity exchanger will depend in part on the materials involved, and on the conditions to which the membrane and other components of the exchanger will be exposed during operation of the device. In some cases it may be necessary to form a robust, gas-tight seal between a water vapor permeable membrane material and itself and/or other components of a heat and humidity exchanger.

### SUMMARY OF THE INVENTION

The present invention is directed toward enclosed membrane structures for heat and humidity exchangers, and methods for their manufacture. Embodiments of the invention can overcome or mitigate challenges related to seam durability and membrane failure.

In at least some embodiments, the invention addresses the problem of stress concentration at seams by introducing non-linear geometry, which distributes mechanical stress over a wider area of the membrane.

The use of non-linear geometry in the seam can be used to reduce the likelihood of leaks or damage at or adjacent to the seam, relative to forming a structure using a linear seam.

In one aspect, a method for forming an enclosed membrane structure for a heat and humidity exchanger includes applying an adhesive strip having non-linear edges to join edges of a sheet of water vapor permeable membrane to form at least one seam, thereby forming the enclosed membrane structure.

In some embodiments, the method may involve forming the enclosed membrane structure by positioning opposite edges of the sheet in an abutting, closely spaced, or slightly overlapping arrangement, and applying the adhesive strip to the opposite edges to form a membrane sleeve.

The membrane sleeve formed by the method may be cylindrical.

In some embodiments of the method, the non-linear edges of the adhesive strip may include smooth, continuous curves.

Where the water vapor permeable membrane includes a substrate with a dense, water vapor permeable coating layer on one surface, the method may include applying the adhesive strip to the uncoated surface of the substrate.

In another aspect, a method for forming an enclosed membrane structure for a heat and humidity exchanger includes applying energy-based welding to join edges of a sheet of water vapor permeable membrane, thereby creating at least one welded seam and forming the enclosed membrane structure. In some embodiments, this includes applying energy-based welding along a non-linear path to join edges of a sheet of water vapor permeable membrane, thereby creating at least one welded seam having a non-linear path and forming the enclosed membrane structure.

The method may involve forming the enclosed membrane structure by arranging opposite edges of the sheet for welding and applying the energy-based welding to the opposite edges to form a membrane sleeve.

In forming the sleeve, the opposite edges of the sheet may be welded directly to each other.

Alternatively, the opposite edges of the sheet may be welded to a strip of material.

The membrane sleeve formed by the welding method may be cylindrical.

The energy-based welding used in the method may include thermal welding using a hot resistive wire.

In some embodiments of the welding method, the non-linear path may include smooth, continuous curves.

In yet another aspect, an enclosed membrane structure for a heat and humidity exchanger includes a sheet of water vapor permeable membrane formed into an enclosed membrane structure having at least one seam created by joining edges of the sheet, wherein the at least one seam includes an adhesive strip having non-linear edges.

The enclosed membrane structure may be a cylindrical sleeve, wherein the adhesive strip is applied to opposite edges of the sheet.

The non-linear edges of the adhesive strip in the enclosed membrane structure may include smooth, continuous curves.

In a further aspect, an enclosed membrane structure for a heat and humidity exchanger includes a sheet of water vapor permeable membrane formed into an enclosed membrane structure having at least one welded seam created by energy-based welding. In some embodiments, the at least one welded seam includes a weld line having a non-linear path.

The enclosed membrane structure may be a cylindrical sleeve formed by welding opposite edges of the sheet.

In such a sleeve, the opposite edges of the sheet may be welded directly to each other.

Alternatively, in such a sleeve, the opposite edges of the sheet may be welded to a strip of material.

The non-linear path of the weld line in the enclosed membrane structure may include smooth, continuous curves.

### BRIEF DESCRIPTION OF THE DRAWINGS

FIG. 1 is a perspective, partial cut-away view of a conventional plate-type heat and humidity exchanger.

FIG. 2 is an isometric view of a membrane cartridge comprising a pleated membrane with flow field elements inserted into the folds on both sides; two of the flow field elements have been pulled out of the folds for illustration purposes.

FIGS. 3-C show a rectangular membrane sheet formed into a cylinder or sleeve by joining two opposite edges together to form a seam, and a flow field element being inserted into the membrane sleeve, according to an embodiment.

FIGS. 4A and 4B show a rectangular membrane sheet formed into a cylinder or sleeve by joining two opposite edges of the membrane sheet together using a strip of membrane soaked in adhesive, according to an embodiment.

FIGS. 5A-C show a rectangular membrane sheet formed into a cylinder or sleeve by joining two opposite edges of the membrane sheet together using a strip of tape, according to an embodiment.

FIG. 6 shows some examples of strips of tape having non-linear edges that can be used to tape opposite edges of a membrane sheet together to form a membrane cylinder or sleeve, according to embodiments.

FIGS. 7A and 7B show a membrane sleeve formed by joining two opposite edges of a rectangular membrane sheet together using wavy tape, according to an embodiment.

FIGS. 8A-D show, in cross-section, different ways opposite edges of a membrane sheet can be arranged in order to be joined by welding them to a strip of material, according to embodiments.

FIGS. 9A and 9B are isometric and side views respectively of an embodiment of a welding apparatus comprising a hot resistive wire.

FIGS. 10A-C are isometric, side and front views respectively of another embodiment of a welding apparatus comprising a hot resistive wire.

FIG. 11 shows a membrane sleeve having a welded seam comprising two non-linear weld lines, according to an embodiment.

FIG. 12 shows a welding block that can be used in a welding apparatus to form a non-linear welded membrane seam, according to an embodiment.

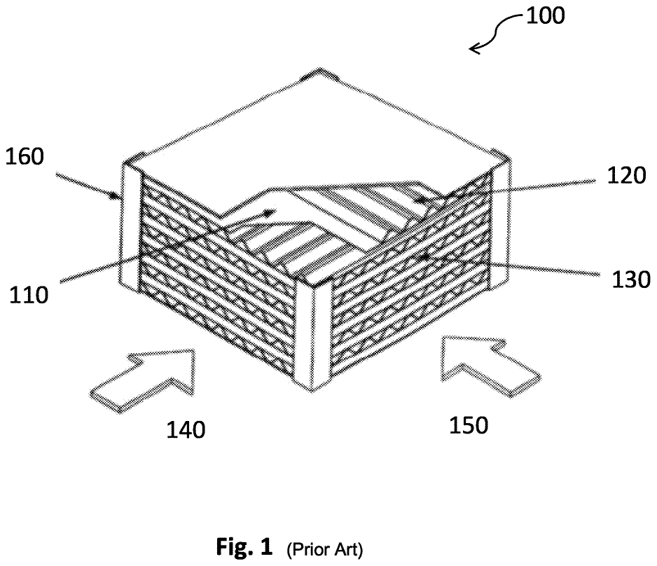

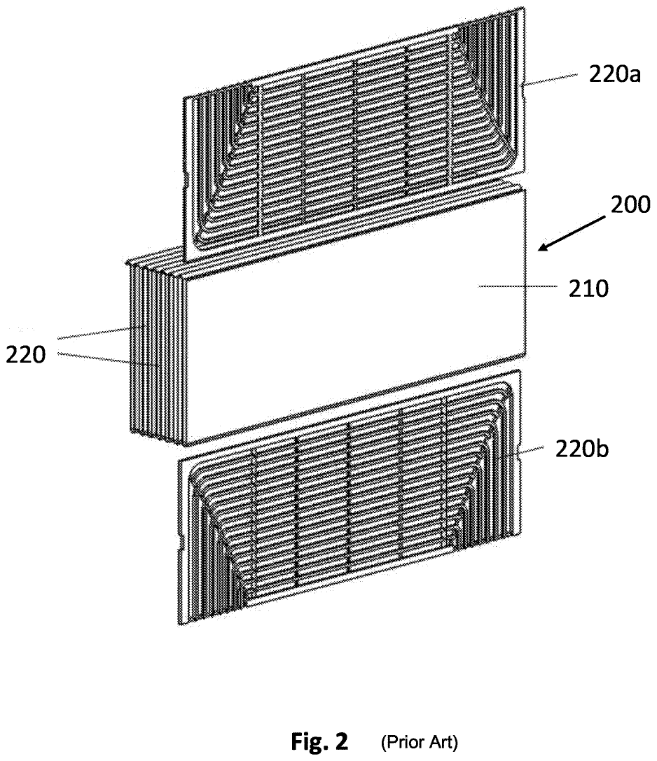

### DETAILED DESCRIPTION

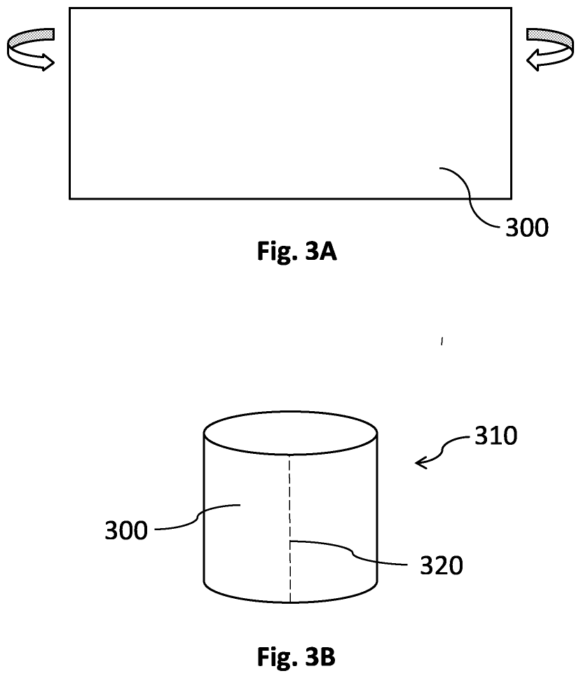

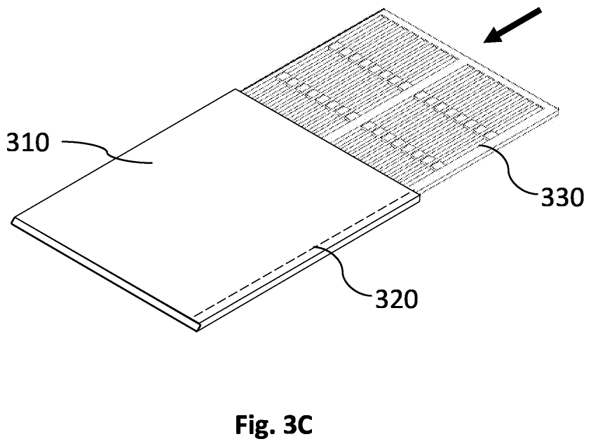

In the present approach, enclosed membrane structures are prepared and used in heat and humidity exchangers. An example embodiment of such a structure is a membrane sleeve. As shown in FIGS. 3A and 3B, in some embodiments, membrane sleeves are prepared by taking a discrete rectangular sheet of membrane 300 and bonding opposite edges of the membrane sheet together to form a membrane cylinder or sleeve 310 having a seam 320. A flow field element 330 can then be inserted into the sleeve 310, for example in the direction of the arrow as shown in FIG. 3C, so that that membrane surrounds or encircles flow field element 330. These units may then be stacked with spacers between them to form a heat and humidity core which can be used in a heat and humidity exchanger. In some embodiments, seam 320, where the two membrane edges have been bonded together, is positioned at or near one edge of the flow field element 330 which is placed inside it, as shown in FIG. 3C.

It can be challenging to join or bond membrane-to-membrane and form a reliable and secure bond that provides a robust and gas-tight seal. The membrane itself can be quite delicate. Also the membrane may tend to swell during use of the heat and humidity exchanger (e.g. some water vapor transport membranes change dimensions based on moisture content), and the dimensional variation may strain the bond or the membrane at or near the seam.

It is generally desirable to join the membrane edges or form the bond so that most of the membrane area in the sleeve is still effective for the transfer of humidity, e.g. to limit or minimize the area of the membrane which is covered or blocked by tape and/or adhesive materials that are not water vapor permeable, or the area in which there is a double layer of (overlapping) membrane.

Depending on the method of joining or bonding the membrane edges together to form a sleeve, it may be possible to take a long piece of membrane, or even a reel of membrane, and join or bond the opposite edges of the membrane together in a “continuous” process to form a long “tube” of membrane, and then cut the tube into discrete pieces or sleeves. This may be more efficient than handling and bonding a discrete piece of membrane to form each sleeve.

Several different methods for joining or bonding membrane edges together to form a membrane sleeve are described below. Embodiments of these methods can be used for various types of water vapor permeable membranes including, but not limited to: multilayer composite membrane materials consisting of, or comprising, a non-woven or other microporous or macroporous support or carrier layer, a microporous layer, and a dense coating layer; membranes consisting only of a microporous layer and a coating layer; membranes consisting only of microporous layers; or membranes consisting only of polymeric films. Suitable non-wovens may include materials consisting of polymeric fibers which are bound through various thermal, adhesive, chemical, mechanical or other processes such as melt-blown, spun-laid, hydro-entangled, or wet-laid non-wovens. The fibers of the non-woven can be homogeneous polymer fibers, or multi-polymer fiber materials, consisting of polymers for example, but not limited to polypropylene, polyethylene, or other polyolefins, polyesters, polyester terephthalate, polyphenylene sulfide, polyurethanes, or polyamides. Suitable microporous layers include, but are not limited to, flexible materials made of polyolefins such as polyethylene, polypropylene, expanded polytetrafluoroethylene (ePTFE), porous polyurethanes, nylons, polyamides, or other microporous polymers. Suitable coating layers include, but are not limited to, water vapor transporting polymers such as, but not limited to, polyurethanes, polyurethane copolymers, polyether-block-amides, polyester copolymers, sulfonated polymers such as sulfonated polyetheretherketone, sulfonated polysulfone, perfluorosulfonic acid polymers, cellulose acetates and other cellulose derivates. The thickness of the membranes used in the methods described below is typically in the range of 25 to 250 microns.

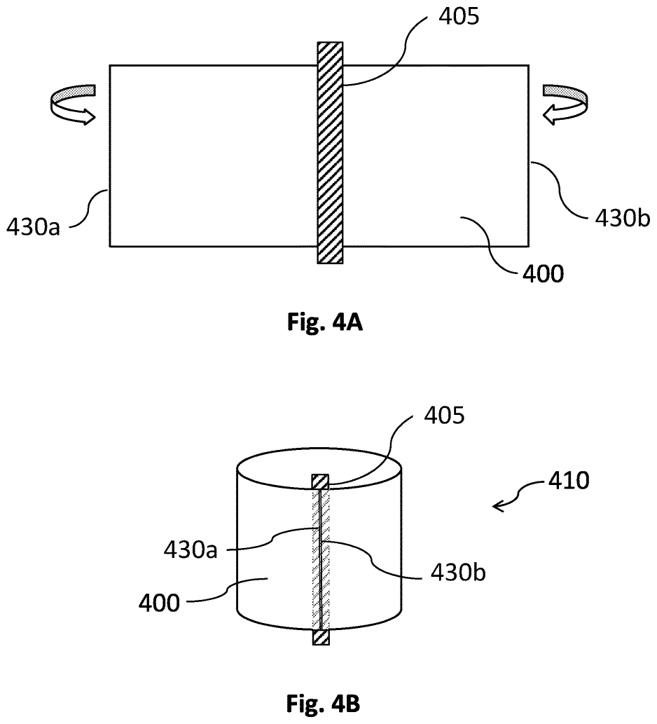

In some embodiments of processes for the manufacture of membrane sleeves for heat and humidity exchangers, the membrane edges are joined using a strip of the same (or a different) membrane material and an adhesive. In some embodiments, for example as shown in FIGS. 4A and 4B, a membrane strip 405 is soaked in an adhesive, then membrane strip 405 is laid out and two opposite edges 430a and 430b of membrane sheet 400 are placed on strip 405 abutting each other to form a sleeve 410, and the adhesive is allowed to cure. In other embodiments, the two opposite edges 430a and 430b of membrane sheet 400 are placed on strip 405 closely spaced to each other, or in other embodiments they are slightly overlapping.

Examples of adhesives that can be used in embodiments of this method include various pressure sensitive adhesives including: acrylics, silicones, polyurethanes, ethylene vinyl acetates, rubbers, or epoxies. Preferably the adhesive is soft and flexible.

With this approach it is possible to form a durable bond and seal with very low leakage risk. However, depending on the adhesive, it can take several hours to dry and cure. This can slow down the overall manufacturing process so that it is not as suitable for high volume manufacturing of heat and humidity exchanger cores.

In some embodiments of processes for the manufacture of membrane sleeves for heat and humidity exchangers, an adhesive tape can be used to bond the membrane edges together. For example, Kapton™ tape coated with acrylic or silicone adhesive (available from Saint-Gobain) can be used. Kapton is a polyimide film made by DuPont that is stable across a wide range of temperatures and is chemically fairly inert. The adhesive on the tape can be, for example acrylic or silicone, the latter being generally more thermally robust. Various other substrates such as PPS or PEEK could be coated or impregnated with acrylic or silicone adhesive and used for the adhesive tape, but may not be as readily available commercially.

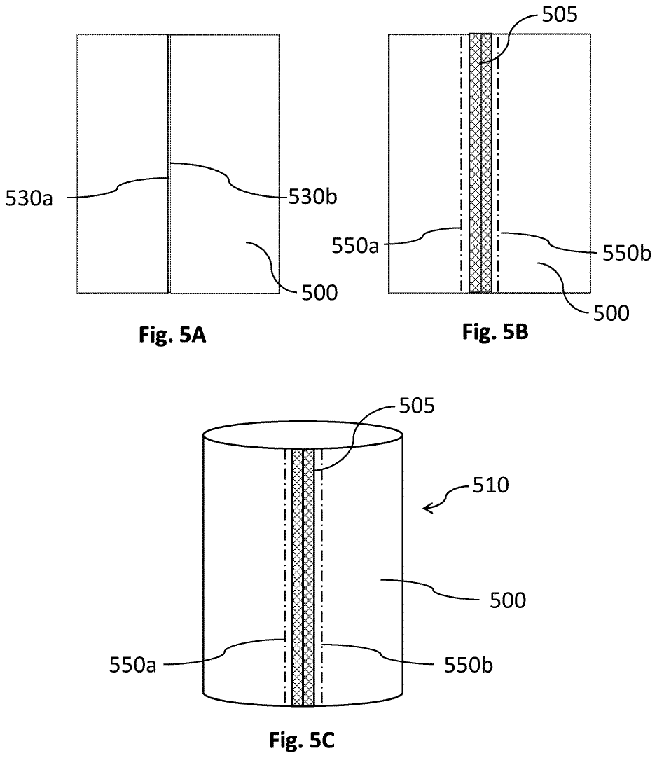

In some embodiments, for example as shown in FIGS. 5A-C, a strip of tape 505 is used to tape opposite edges 530a and 530b of a membrane sheet 500 together to form a membrane sleeve 510. The membranes edges 530a and 530b are abutting each other as shown in FIGS. 5A-C, or closely spaced to each other or slightly overlapping in other embodiments.

When a strip of tape having straight (linear) edges is used to join the two membrane edges together to form a membrane sleeve, it has been found that when the sleeve is in use in a heat and humidity exchanger there can be a tendency for the membrane to fail along a line offset slightly from each edge of the tape, e.g. shown in FIG. 5B and FIG. 5C as dot-dash lines 550a and 550b. It is speculated that the straight edges of the tape create a substantially uniform distribution of force along an adjacent parallel line on the membrane (on each side of the seam), and that this stress concentration can cause localized stretching of the membrane. It seems likely that this focused stress weakens the membrane and/or coating and can lead to potential leaks or damage. In testing using several different types of tape material, it has been found that leakage across the membrane when the membrane in the vicinity of the seam is subjected to a pressure differential across it (for example by pressurizing it with air on one side and having water on the other side, so that leakage produces air bubbles in the water) tends to concentrate at a distance of between 0.5 and 1 millimeter from both edges of the tape.

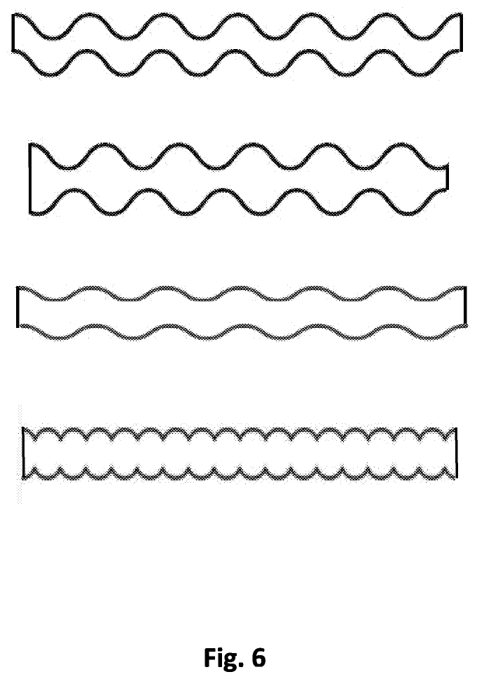

It has been discovered that using tape having non-linear edges can result in a significant reduction in membrane failure and leakage near the seam. For example, various tapes having scalloped or wavy edges have given excellent results. Without being bound by theory, it is speculated that when the tape having non-linear edges is used, the stress near the taped seam is distributed across a wider area of the membrane, rather than being concentrated along a line. This can reduce the likelihood of leaks or damage, as verified by testing. FIG. 6 shows four examples of tape having edges that are non-linear (not straight), and that can be used to tape opposite edges of a membrane sheet together to form a membrane sleeve. In some embodiments the non-linear tape edges have smooth, continuous curves, which as discussed above have given excellent results. In other embodiments the non-linear tape edges may include one or more sharp transitions (e.g. zig zag), however, it has been found that sharp transitions in the tape edges can in some cases result in localized leak points in the membrane near the seam, likely due to stress concentrations.

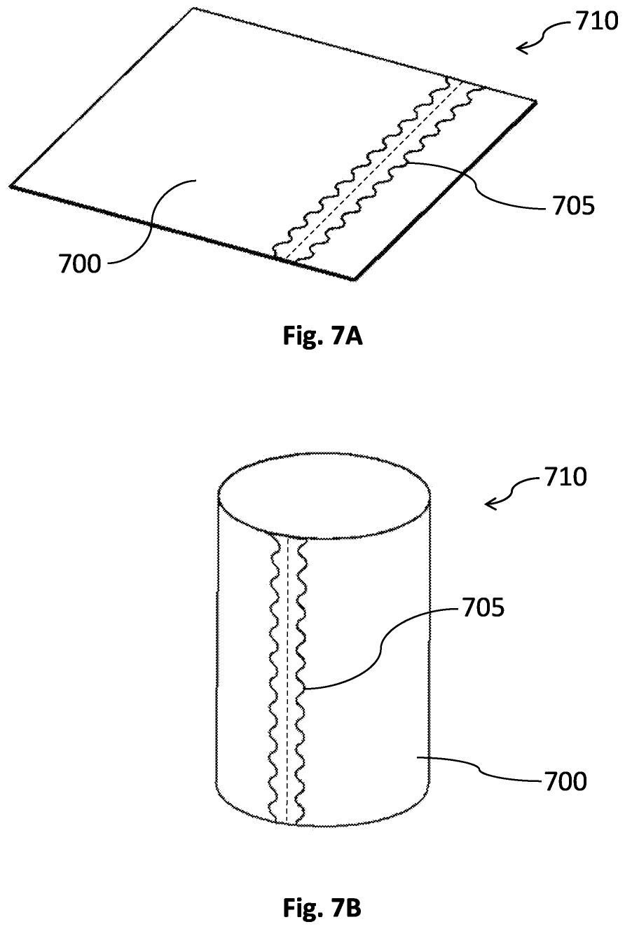

FIGS. 7A and 7B illustrate a membrane sleeve 710 (shown flattened in FIG. 7A, and opened up to form a membrane cylinder in FIG. 7B) formed by joining opposite edges of a rectangular membrane sheet 700 together using wavy tape 705.

The abutting (or closely spaced or slightly overlapping) edges of the membrane that are taped together can be straight, as shown in FIGS. 5A-C and FIGS. 7A and 7B, for example. In other embodiments, the edges of the membrane can be non-linear, for example, wavy or scalloped in the same manner as the tape or in a different manner.

In FIGS. 5A-C and FIGS. 7A and 7B the tape is shown on the outside of the membrane sleeve, however the tape can be applied to the outside or inside of the membrane sleeve, or both. The preferred location can depend, for example, on the membrane and tape material, the heat and humidity exchanger architecture, and the operating configuration and conditions of the heat and humidity exchanger.

For example, in some cases the membrane may have one surface coated with a dense water vapor permeable layer that can absorb water vapor, and the opposing membrane surface may be a microporous substrate. In some such cases it may be beneficial to apply the tape to the microporous substrate surface of the membrane, so that the tape is bonded to material that is more dimensionally stable in the presence of water or water vapor.

In some cases, the water vapor permeable coating layer of the membrane may be positioned in a heat and humidity exchanger to interface with a gas stream that is dryer and at higher pressure than the gas stream contacting the opposing membrane surface. In some such cases, it may be beneficial to apply the adhesive tape to the coated membrane surface so that a better seal is created between the adhesive tape and the coating, and there is less tendency for gas to pass under the tape and through the membrane to the opposing side.

In some embodiments of processes for the manufacture of membrane sleeves for heat and humidity exchangers the membrane edges are welded together, either directly or via another piece of material. Different types of energy-based welding can be used, for example, thermal welding, or welding using ultrasound or laser beams.

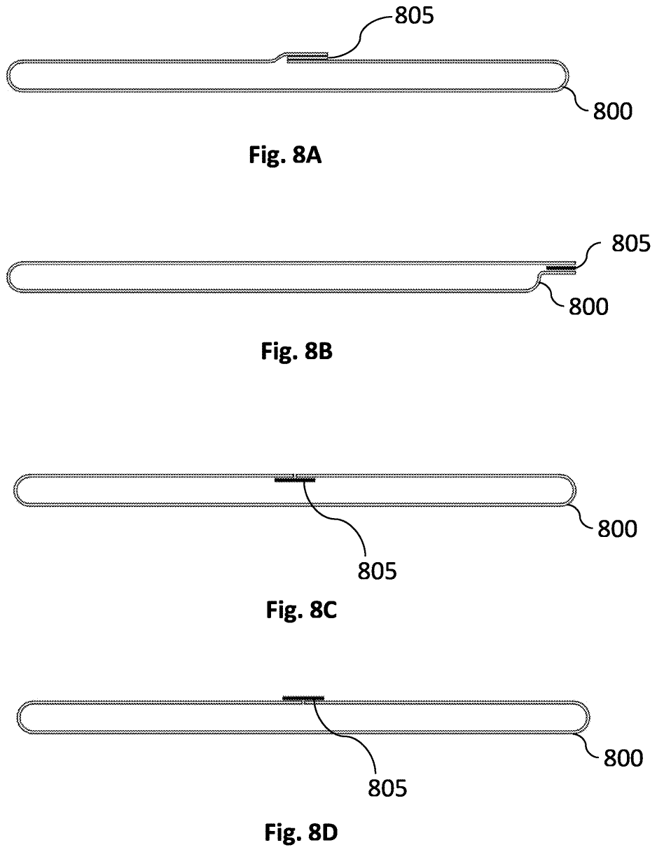

For example, for membranes comprising a polyethylene terephthalate (PET) non-woven substrate with an ePTFE microporous layer and a selective water vapor permeable coating, a strip of PET can be thermally welded to the membrane edges that are to be joined together. FIGS. 8A-D show (in cross-section) different ways opposite edges of a membrane sheet 800 can be arranged for welding with a PET strip 805. If the membrane is asymmetric (e.g. with a coating on one side), the option illustrated in FIG. 8A requires PET strip 805 to be welded to two different materials, which can be more challenging. With the configuration illustrated in FIGS. 8B, 8C and 8D the PET 805 strip is welded to the same face of membrane 800 along both edges and therefore to the same material, but the option illustrated in FIG. 8B is harder to flatten once welded. A third option, shown in FIG. 8C, is generally preferred, especially if membrane 800 has a substrate and a coating, with the membrane edges abutting (rather than overlapped) and the non-coated surface of membrane 800 welded to the PET strip 805. A fourth option, shown in FIG. 8D, has the PET strip 805 on the outside of the membrane sleeve. If membrane 800 has a substrate and a coating, and the membrane edges are abutting as shown, the coated or the non-coated surface of membrane 800 can be welded to the PET strip 805, the latter being generally preferred.

In some embodiments, thermal welding using a hot resistive wire, with electrical current passing through it, can be used. The hot wire can be brought into contact with the membrane or vice versa. In some embodiments, a vacuum rod can be used to pull the membrane against the hot wire.

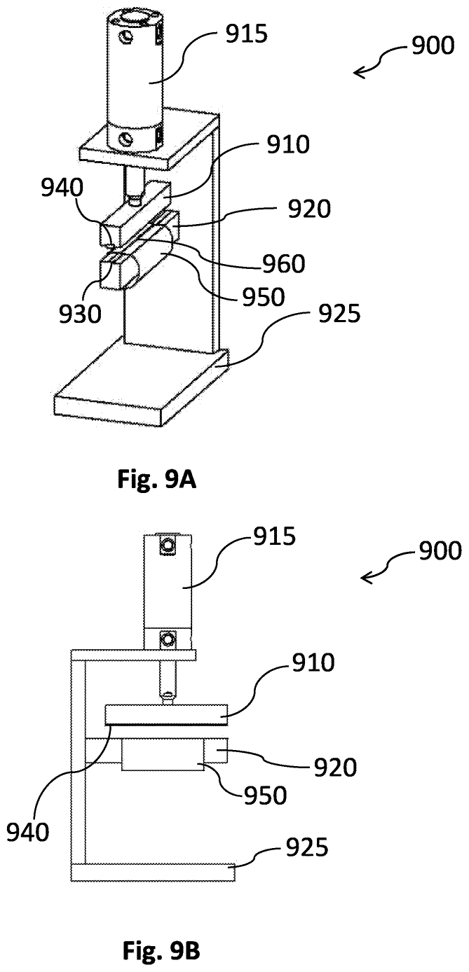

FIGS. 9A and 9B are isometric and side views respectively of an embodiment of a welding apparatus 900 comprising a hot resistive wire 930. Welding apparatus 900 comprises an upper welder jaw 910 and a lower welder jaw 920. Upper welder jaw 910 is attached to a pneumatic cylinder 915, and lower welder jaw 920 is in a cantilever arrangement, fixed to a welder structure or base 925. Lower jaw 920 is made of mica, which is non-conductive, and serves as a base to support a nichrome wire 930 used for welding. Upper jaw 910 includes a strip of silicone gasket 940 that (when the pneumatic cylinder is activated) presses against the membrane and membrane edges to hold them in position during the welding process. A membrane sleeve 950 having welded seam 960 formed by thermal welding using nichrome wire 930 is shown in FIGS. 9A and 9B. In other embodiments, hot resistive wire 930 may be made of suitable resistive material other than nichrome, and lower jaw 920 may be made of a suitable non-conductive material other than mica.

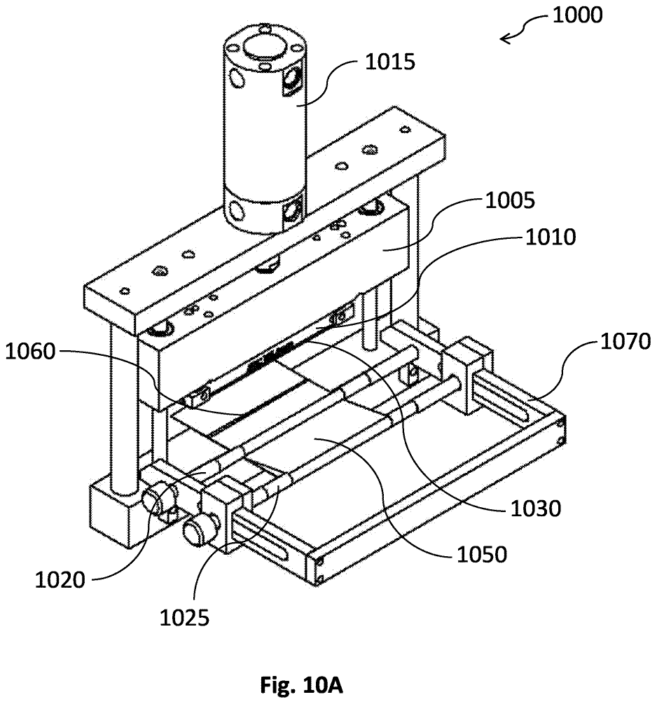

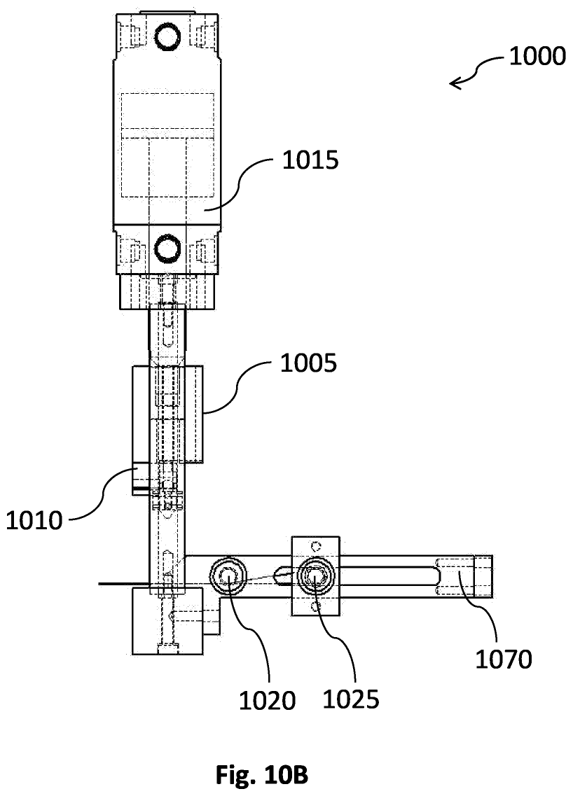

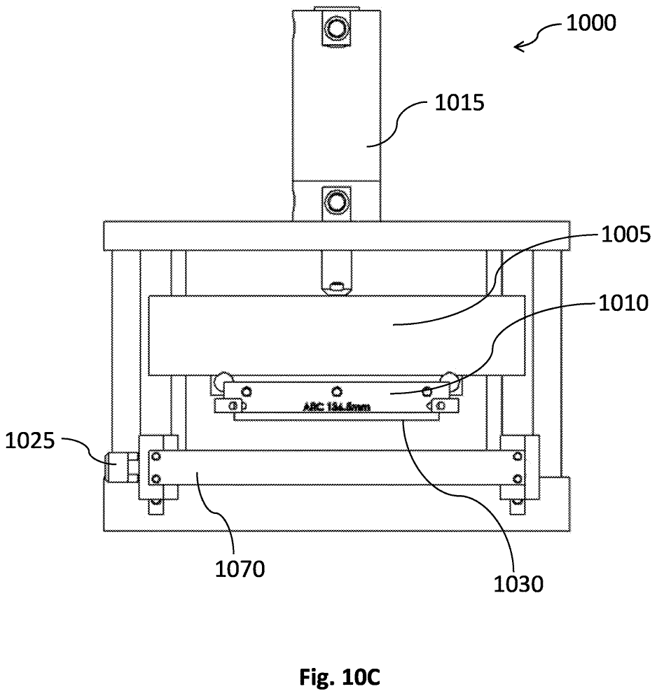

FIGS. 10A-C are isometric, side and front views respectively of another embodiment of a welding apparatus 1000 comprising a hot resistive wire 1030. A mobile soldier block 1005 has a hot wire block 1010 on its lower side which supports a nichrome wire 1030 used for welding. A pair of forming rollers 1020 and 1025 are used to shape the membrane sleeve 1050. A pneumatic cylinder 1015 is activated to press nichrome wire 1030 against the membrane, releasing a controlled current pulse to weld the membrane edges together to form membrane sleeve 1050 having welded seam 1060. Hot wire block 1010 is interchangeable for other blocks of different sizes to allow manufacture of membrane sleeves of various widths. A jig 1070 is used for distance calibration. Process parameters such as temperature, voltage, pressure, contact time, membrane tension can be adjusted depending on the material(s) involved, to improve the integrity of the weld. In some cases welding can provide a robust bond in the membrane sleeve, however, in some cases the membrane tends to be more vulnerable to failure along the edge where it was heated during the welding process.

The weld line may be straight or may be non-linear, for example, having a zig-zag or wavy path. Using a non-linear weld line may offer advantages similar to those discussed above with respect to using a tape having non-linear edges. For example, it can improve stress distribution and/or result in a reduction in membrane failure and leakage near the welded seam. Also, a non-linear weld line can increase the bonding contact area. Furthermore, to strengthen the welded joint, more than one weld line can be used, for example, a second weld having a path that is close to and parallel with the first weld line can be used

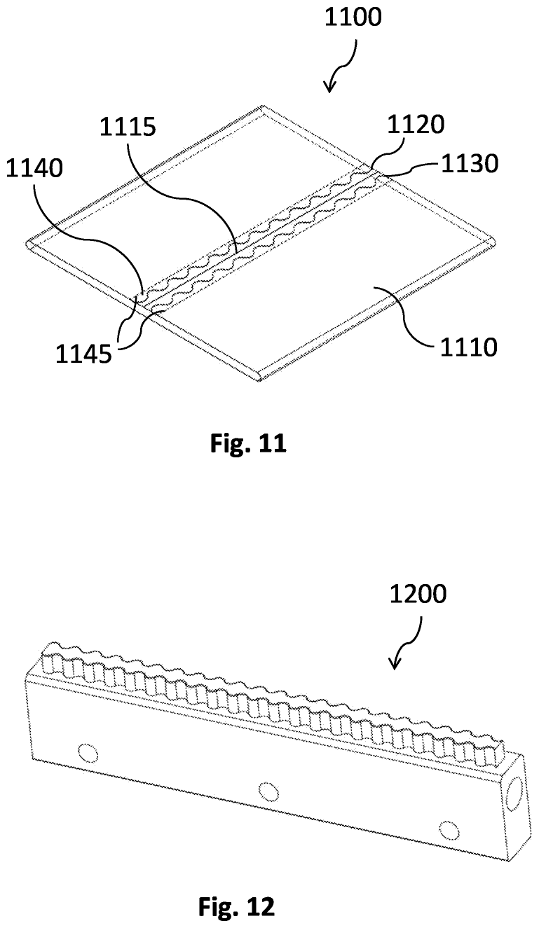

FIG. 11 shows an example of a membrane sleeve 1100 having a welded seam. The edges of membrane 1110 abut each other at line 1115, and are each welded via wavy weld lines, 1120 and 1130, respectively, to a strip of material 1140 (for example, a PET strip) indicated by dashed lines 1145 in an arrangement similar to that shown in FIG. 8C.

FIG. 12 shows a welding block 1200 (similar to hot wire block 1010 of FIGS. 10A-C) that can be used in a welding apparatus to form a membrane sleeve having a welded seam with wavy weld lines.

The methods described above for joining or bonding a water vapor permeable membrane material to itself can be used to join and form enclosed membrane structures in other configurations besides cylindrical sleeves, and for other applications besides heat and humidity exchangers. For example, some embodiments of the methods can be used to form rectangular membrane pockets which are folded along one side, bonded along two sides, and open on fourth side (or bonded along three sides and open on the fourth side). Embodiments of the methods described herein can also be used to join two or more sheets of water vapor permeable membrane together to form enclosed membrane structures, such as membrane sleeves or pockets.

Embodiments of the methods described above for joining a water vapor permeable membrane material to itself can be used for different types of water vapor permeable membranes, including selective water vapor transport membranes. The membrane can be a multi-layer material, for example, comprising a macroporous substrate, and/or a nanofibrous layer, either or both of which may be impregnated with another material; the membrane may comprise one or more coatings. The membrane can be a microporous material and/or a microporous material with a water vapor permeable coating layer on one or both surfaces. The membrane can be symmetrical (i.e. substantially the same on both faces) or may be asymmetric, for example, with a coating on one face. If it is asymmetric, the orientation of the membrane with respect to how it is joined may be chosen to suit the materials involved, for example, so that like surfaces are joined together or not.

### INTERPRETATION OF TERMS

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“joined”, “bonded”, “connected”, “coupled”, or any variant thereof, means any physical join, connection or coupling, either direct or indirect, between two or more elements;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Words that indicate directions such as “vertical”, “transverse”, “horizontal”, “upward”, “downward”, “upper”, “lower”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Where a component (e.g. a membrane, sealant, adhesive, wire, gasket, tape, jaw, assembly, device, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting or combining features, elements and/or acts from described embodiments.

Various features are described herein as being present in “some embodiments”. Such features are not mandatory and may not be present in all embodiments. Embodiments of the invention may include zero, any one or any combination of two or more of such features. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B even if features A and B are described with respect to different Figures and/or are mentioned in different paragraphs or different sentences (unless the description states otherwise or features A and B are fundamentally incompatible).

While particular elements, embodiments and applications of the present invention have been shown and described, it will be understood, that the invention is not limited thereto since modifications can be made by those skilled in the art without departing from the scope of the present disclosure, particularly in light of the foregoing teachings. It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

What is claimed is:

1. A method for forming an enclosed membrane structure for a heat and humidity exchanger, the method comprising: applying an adhesive strip having non-linear edges to join edges of a sheet of water vapor permeable membrane to form at least one seam, thereby forming the enclosed membrane structure.

2. The method according to claim 1, wherein forming the enclosed membrane structure comprises positioning opposite edges of the sheet in an abutting, closely spaced, or slightly overlapping arrangement and applying the adhesive strip to the opposite edges to form a membrane sleeve.

3. The method according to claim 1, wherein the non-linear edges of the adhesive strip reduce stress concentration in the water vapor permeable membrane adjacent to the seam relative to using an adhesive strip with linear edges.

4. The method according to claim 1, wherein the non-linear edges comprise smooth, continuous curves.

5. The method according to claim 1, wherein the water vapor permeable membrane comprises a substrate having a dense, water vapor permeable coating layer on one surface thereof, and wherein the adhesive strip is applied to the uncoated surface of the substrate.

6. A method for forming an enclosed membrane structure for a heat and humidity exchanger, the method comprising: applying energy-based welding to join edges of a sheet of water vapor permeable membrane, thereby creating at least one welded seam and forming the enclosed membrane structure.

7. The method according to claim 6, wherein the energy-based welding is applied along a non-linear path, thereby creating at least one welded seam having a non-linear path.

8. The method according to claim 6, wherein forming the enclosed membrane structure comprises arranging opposite edges of the sheet for welding and applying the energy-based welding to the opposite edges to form a membrane sleeve.

9. The method according to claim 8, wherein the opposite edges of the sheet are welded directly to each other.

10. The method according to claim 8, wherein the opposite edges of the sheet are welded to a strip of material.

11. The method according to claim 6, wherein the energy-based welding comprises thermal welding using a hot resistive wire.

12. The method according to claim 6, wherein the non-linear path comprises smooth, continuous curves.

13. An enclosed membrane structure for a heat and humidity exchanger, comprising a sheet of water vapor permeable membrane formed into an enclosed membrane structure comprising at least one seam created by joining edges of the sheet, wherein the at least one seam comprises an adhesive strip comprising non-linear edges.

14. An enclosed membrane structure according to claim 13, wherein the enclosed membrane structure is a cylindrical sleeve, and wherein the adhesive strip comprising non-linear edges is applied to opposite edges of the sheet to form the seam.

15. An enclosed membrane structure according to claim 13 wherein the non-linear edges comprise smooth, continuous curves.

16. An enclosed membrane structure for a heat and humidity exchanger, comprising a sheet of water vapor permeable membrane formed into an enclosed membrane structure comprising at least one welded seam created by energy-based welding to join edges of the sheet.

17. An enclosed membrane structure according to claim 16, wherein the at least one welded seam comprises a weld line having a non-linear path.

18. An enclosed membrane structure according to claim 16, wherein the enclosed membrane structure is a cylindrical sleeve formed by welding opposite edges of the sheet.

19. An enclosed membrane structure according to claim 18, wherein the opposite edges are welded directly to each other to create the welded seam.

20. An enclosed membrane structure according to claim 18 wherein the opposite edges of the sheet are welded to a strip of material to create the welded seam.
